(19) United States
(12) Patent Application Publication
(10) Pub. No.: US 2018/0046560 A1
(43) Pub. Date: Feb. 15, 2018

(54) DEVICE-AGNOSTIC SYSTEMS, METHODS, AND MEDIA FOR CONNECTED HARDWARE-BASED ANALYTICS

(71) Applicant: Dash Robotics, Inc., Hayward, CA (US)

(72) Inventors: Andrew George GILLIES, Oakland, CA (US); Christopher Adam OVERHOLTZER, Mountain View, CA (US); Dwight SPRINGTHORPE, II, Albany, CA (US); Nicholas Joseph KOHUT, Mountain View, CA (US)

(21) Appl. No.: 15/675,284

(22) Filed: Aug. 11, 2017

Related U.S. Application Data
(60) Provisional application No. 62/374,453, filed on Aug. 12, 2016.

(51) Int. Cl. G06F 11/30; G06F 21/44; H04L 29/08

(52) U.S. Cl. CPC G06F 11/3051; H04L 67/303; G06F 21/44

(57) ABSTRACT

Systems, methods, and media for tracking a connected device are disclosed. For example, a wireless connection can be established between a user computing device and a connected hardware device. The user computing device can determine whether a Universally Unique Identifier (UUID) has been assigned to the connected hardware device. If no UUID has been assigned, the user computing device can generate a UUID, which the connected hardware device can receive and store. The user computing device can instruct a server to create a profile of the connected hardware device with the UUID. The connected hardware device can start broadcasting the UUID. A second user computing device can receive the UUID and retrieve the profile of the connected hardware device from the server with the UUID. The connected hardware device can also collect information, which can be transmitted to the server via a user computing device.

### RELATED APPLICATION

This application claims benefit under 35 U.S.C. §119(e) to U.S. Provisional Patent Application No. 62/374,453, filed on Aug. 12, 2016, titled “Phone-Agnostic Systems and Methods for Connected Hardware-Based Analytics,” which is explicitly incorporated by reference herein in its entirety.

### BACKGROUND OF THE INVENTION

### Technical Field

Embodiments of the present disclosure relate to systems, methods, and computer readable media in the field of connected devices. The present disclosure has uses in any suitable hardware product that connects to a user's computing device.

### Description of the Related Art

Connected devices with electronic hardware can connect wirelessly to mobile devices, such as tablets, smartphones, or personal computers via WiFi, Bluetooth, or other communication protocols. Software typically accompanies the connected devices (usually in the form of a downloadable application or app), and can be upgraded and modified with new features that are released over time. The accompanying software also provides analytics data. This analytics data can be processed by the developers to better understand when and how the consumer is using the connected device, allowing the developers to make more accurately informed decisions on a variety of topics, such as product development, marketing, and customer support.

Collecting user data raises privacy and security issues, especially when that user data comes from an individual under the age of thirteen. In the United States, Child Online Privacy Protection Rule (COPPA) states that one cannot collect or store any personally identifiable information of a child thirteen years of age or younger without following strict legal requirements. Off-the-shelf analytics tools (e.g., Google Analytics) do not meet these guidelines, as personally identifiable information is nearly always collected, either directly or in aggregate, be it in the form of device location, IP address, phone number, etc. As well, many analytics tools are based on tracking the controlling device (e.g., the smartphone or tablet) and are not specifically configured to collect analytics from the connected device itself. Therefore, a need exists to collect analytics data at the connected hardware level, in a manner that avoids the collection of any personally identifiable information.

### SUMMARY

In accordance with the disclosed subject matter, systems, methods, and computer readable media are provided for tracking connected devices.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

A method of tracking a connected hardware device according to one embodiment of the present disclosure can include establishing, at a first user computing device, a first wireless connection from a connected hardware device; receiving, at the first user computing device, first data from the connected hardware device; based on the first data, determining, at the first user computing device, whether a Universally Unique Identifier (UUID) that uniquely identifies the connected hardware device has been assigned to the connected hardware device; when it is determined that no UUID has been assigned to the connected hardware device: generating, at the first user computing device, a UUID that uniquely identifies the connected hardware device, transmitting, from the first user computing device to the connected hardware device, the UUID to assign the UUID to the connected hardware device, and instructing, by the first user computing device, a server to create a profile of the connected hardware device with the UUID; establishing, at a second user computing device, a second wireless connection from the connected hardware device; receiving, at the second user computing device, second data from the connected hardware device; based on the second data, determining, at the second user computing device, whether the UUID has been assigned to the connected hardware device; and when it is determined that the UUID has been assigned to the connected hardware device: transmitting, from the second user computing device to the server, the UUID, requesting, from the server by the second user computing device, the profile of the connected hardware device with the UUID, and receiving, at the second user computing device from the server, the profile of the connected hardware device.

According to some embodiments, the second user computing device can be the same or different as the first user computing device.

According to some embodiments, when it is determined that no UUID has been assigned to the connected hardware device, the method can further include instructing, by the first user computing device, the server to create the profile based on third data including at least one of user-created data, a name, a description, an initialization date, or a firmware version.

According to some embodiments, the method can further include receiving, at the second user computing device from the connected hardware device, third data including information collected by, and relating to, the connected hardware device.

According to some embodiments, the collected information can include at least one of a usage time, a distance travelled, sensor data, one or more games played, or one or more actions performed.

According to some embodiments, the method can further include transmitting, from the second user computing device to the server, the collected information; and instructing, by the second user computing device, the server to update the profile of the connected hardware device with the collected information.

According to some embodiments, the UUID can be a probabilistically unique value.

According to some embodiments, the method can further include receiving, at the first or the second user computing device from the server, a notification regarding the connected hardware device.

According to some embodiments, the method can further include retrieving, at the first or the second user computing device from an accessory coupled to the connected hardware device, a unique accessory code that has not been associated with any connected hardware device on the server; generating, at the first or the second user computing device, a second UUID for the accessory based on the unique accessory code; and instructing, by the first or the second user computing device, the server to associate the accessory with the connected hardware device based at least on the UUID and the second UUID.

According to some embodiments, the connected hardware device can be one of a medical device, an appliance, a wireless heart rate monitor, a smart toy, or a wireless webcam.

A method of tracking a connected hardware device according to one embodiment of the present disclosure can include broadcasting, from a connected hardware device, first data from the connected hardware device; when no UUID has been assigned to the connected hardware device: receiving, at the connected hardware device from a first user computing device, a UUID that uniquely identifies the connected hardware device, storing, at the connected hardware device, the UUID, and associating, at the connected hardware device, the UUID with the connected hardware device; broadcasting, from the connected hardware device, second data including the UUID; collecting, by the connected hardware device, information relating to the connected hardware device; and transmitting, from the connected hardware device to a second user computing device, third data including the collected information relating to the connected hardware device.

According to some embodiments, the second user computing device can be the same or different as the first user computing device.

According to some embodiments, the method can further include collecting, by the connected hardware device, the information from one or more sensors.

According to some embodiments, the one or more sensors can include at least one of an accelerometer, a visible light sensor, or an infrared signal sensor.

According to some embodiments, the collected information can include at least one of a usage time, a distance travelled, sensor data, one or more games played, or one or more actions performed.

According to some embodiments, the connected hardware device can be one of a medical device, an appliance, a wireless heart rate monitor, a smart toy, or a wireless webcam.

A user computing device according to one embodiment of the present disclosure can include a memory that stores a module; and a processor configured to run the module stored in the memory that is configured to cause the processor to: establish a first wireless connection from a connected hardware device; receive first data from the connected hardware device; based on the first data, determine whether a UUID that uniquely identifies the connected hardware device has been assigned to the connected hardware device; when it is determined that no UUID has been assigned to the connected hardware device: generate a UUID that uniquely identifies the connected hardware device, transmit the UUID to the connected hardware device to assign the UUID to the connected hardware device, and instruct a server to create a profile of the connected hardware device with the UUID; establish a second wireless connection from the connected hardware device; receive second data from the connected hardware device; based on the second data, determine whether the UUID has been assigned to the connected hardware device; and when it is determined that the UUID has been assigned to the connected hardware device: transmit the UUID to the server, request the profile of the connected hardware device with the UUID from the server, and receive the profile of the connected hardware device from the server.

According to some embodiments, the processor can be further configured to run the module stored in the memory that is configured to cause the processor to: when it is determined that no UUID has been assigned to the connected hardware device, instruct the server to create the profile based on third data comprising at least one of user-created data, a name, a description, an initialization date, or a firmware version.

According to some embodiments, the processor can be further configured to run the module stored in the memory that is configured to cause the processor to: receive third data comprising information collected by, and relating to, the connected hardware device from the connected hardware device; transmit the collected information to the server; and instruct the server to update the profile of the connected hardware device with the collected information.

According to some embodiments, the UUID can be a probabilistically unique value.

According to some embodiments, the processor can be further configured to run the module stored in the memory that is configured to cause the processor to: receive a notification regarding the connected hardware device from the server.

According to some embodiments, the processor can be further configured to run the module stored in the memory that is configured to cause the processor to: retrieve, from an accessory coupled to the connected hardware device, a unique accessory code that has not been associated with any connected hardware device on the server; generate a second UUID for the accessory based on the unique accessory code; and instruct the server to associate the accessory with the connected hardware device based at least on the UUID and the second UUID.

A connected hardware device according to one embodiment of the present disclosure can include a memory that stores a module; and a processor configured to run the module stored in the memory that is configured to cause the processor to: broadcast first data from the connected hardware device; when no Universally Unique Identifier (UUID) has been assigned to the connected hardware device: receive a UUID that uniquely identifies the connected hardware device from a first user computing device, store the UUID, and associate the UUID with the connected hardware device; broadcast second data including the UUID; collect information relating to the connected hardware device; and transmit third data including the collected information relating to the connected hardware device to a second user computing device.

According to some embodiments, the second user computing device can be the same or different as the first user computing device.

According to some embodiments, the processor can be further configured to run the module stored in the memory that is configured to cause the processor to collect the information from one or more sensors.

According to some embodiments, the collected information can include at least one of a usage time, a distance travelled, sensor data, one or more games played, or one or more actions performed.

According to some embodiments, the connected hardware device is one of a medical device, an appliance, a wireless heart rate monitor, a smart toy, or a wireless webcam.

A non-transitory computer readable medium according to one embodiment of the present disclosure can have executable instructions operable to cause an apparatus to: establish a first wireless connection from a connected hardware device; receive first data from the connected hardware device; based on the first data, determine whether a UUID that uniquely identifies the connected hardware device has been assigned to the connected hardware device; when it is determined that no UUID has been assigned to the connected hardware device: generate a UUID that uniquely identifies the connected hardware device, transmit the UUID to the connected hardware device to assign the UUID to the connected hardware device, and instruct a server to create a profile of the connected hardware device with the UUID; establish a second wireless connection from the connected hardware device; receive second data from the connected hardware device; based on the second data, determine whether the UUID has been assigned to the connected hardware device; and when it is determined that the UUID has been assigned to the connected hardware device: transmit the UUID to the server, request the profile of the connected hardware device with the UUID from the server, and receive the profile of the connected hardware device from the server.

According to some embodiments, the non-transitory computer readable medium can further have executable instructions operable to cause the apparatus to: when it is determined that no UUID has been assigned to the connected hardware device, instruct the server to create the profile based on third data comprising at least one of user-created data, a name, a description, an initialization date, or a firmware version.

According to some embodiments, the non-transitory computer readable medium can further have executable instructions operable to cause the apparatus to: receive third data comprising information collected by, and relating to, the connected hardware device from the connected hardware device; transmit the collected information to the server; and instruct the server to update the profile of the connected hardware device with the collected information.

According to some embodiments, the UUID can be a probabilistically unique value.

According to some embodiments, the non-transitory computer readable medium can further have executable instructions operable to cause the apparatus to: retrieve, from an accessory coupled to the connected hardware device, a unique accessory code that has not been associated with any connected hardware device on the server; generate a second UUID for the accessory based on the unique accessory code; and instruct the server to associate the accessory with the connected hardware device based at least on the UUID and the second UUID.

A non-transitory computer readable medium according to one embodiment of the present disclosure can have executable instructions operable to cause an apparatus to: broadcast first data from a connected hardware device; when no UUID has been assigned to the connected hardware device: receive a UUID that uniquely identifies the connected hardware device from a first user computing device, store the UUID, and associate the UUID with the connected hardware device; broadcast second data including the UUID; collect information relating to the connected hardware device; and transmit third data including the collected information relating to the connected hardware device to a second user computing device.

According to some embodiments, the non-transitory computer readable medium can further have executable instructions operable to cause the apparatus to collect the information from one or more sensors.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

FIG. 1 illustrates a system in accordance with embodiments of the present disclosure.

FIG. 2 illustrates a block diagram of a connected device in accordance with embodiments of the present disclosure.

FIG. 3 illustrates a block diagram of a user connecting device in accordance with embodiments of the present disclosure.

FIG. 4 illustrates a block diagram of a server in accordance with some embodiments of the present disclosure.

FIGS. 5A-5B illustrate a method of generating, assigning, and sharing a UUID in accordance with embodiments of the present disclosure.

FIG. 6 illustrates analytics network architecture and a related method in accordance with embodiments of the present disclosure.

FIG. 7 illustrates a method of using connected device data to solicit event-triggered feedback from the user.

FIGS. 8A-8B illustrate a method of tracking an accessory in accordance with embodiments of the present disclosure.

FIG. 9 illustrates a method of tracking a connected hardware device in accordance with embodiments of the present disclosure.

FIG. 10 illustrates a method of tracking a connected hardware device in accordance with embodiments of the present disclosure.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

Disclosed systems, methods, and media relate to tracking (1) a connected device, (2) the connected device's interaction with a user computing device, and (3) the connected device and the user computing device's collection of data relating to the connected device. Mechanisms on how various types of data are collected, stored, and maintained for analysis are disclosed. According to aspects of the present disclosure, connected devices can be tracked by collecting data (e.g., analytics data) associated with the connected devices at the connected device level instead of using or collecting any personally identifiable information.

According to some embodiments, a connected device can be any physical or hardware device that a user can connect using a user computing device. Examples of connected devices can include a robot, a toy robot, a medical device, a fitness tracker, a smart home device, a heart rate monitor, a connected toy, a connected smart toy, a wireless webcam, a Bluetooth beacon, and/or any other suitable device that can connect to a user computing device. Connections with connected devices can be established via a wireless and/or wired network. Examples of user computing devices can include a mobile phone, a tablet, a personal computer, or any other suitable user computing device.

According to some embodiments, a connected device can include one or more of a microprocessor, on-board memory, a means of connection (e.g., Bluetooth, WiFi, and any other industry-standard or proprietary connection protocols), sensors that collect data, output devices (e.g., LEDs, physical actuators, and/or any other suitable output device), input devices (e.g., input ports, camera, and/or any other suitable input device), and/or any other suitable components. In some embodiments, a connected device can generate data and transmit the data to a user computing device. The transmitted data can have a variety of uses. For example, the transmitted data can be used for performing data analysis, describing the state of the connected device, describing the state of the environment of the connected device, providing entertainment, and/or any other suitable use.

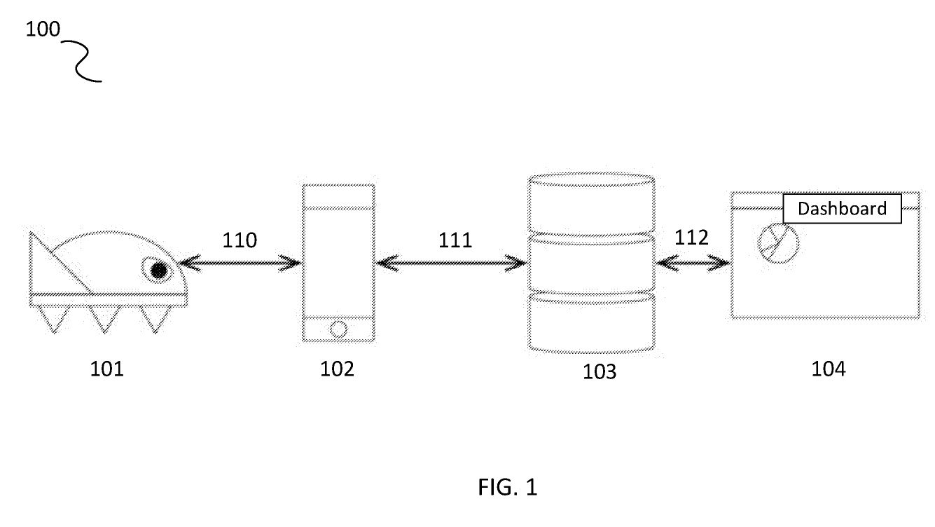

FIG. 1 illustrates a system 100 in accordance with embodiments of the present disclosure. The system 100 can include a connected device 101, a user computing device 102, a server 103, and a user interface 104. Many of the figures in the current disclosure show a robot as the connected device 101 for illustrative purposes but the connected device 101 can be any other suitable connected device. Moreover, many of the figures in the current disclosure show a mobile phone as the user computing device 102 for illustrative purposes but the user computing device 102 can be any other suitable user computing device.

The server 103 can be any type of computing device that allows processing and/or storage of data. For example, the server 103 can be a web server providing a Mobile Backend as a Service (MBaaS) with cloud storage and backend APIs, which can store and access analytics data. The user interface 104 can receive data from the server 103 and present data in a user-friendly form. For example, the user interface 104 can provide visualization of the data by using a dashboard tool. The dashboard tool can be a web application or a mobile application that creates analytics visualizations from analytics data stored in the server 103.

According to some embodiments, the connected device 101 can broadcast its existence by, for example, transmitting a wireless signal. In some embodiments, Bluetooth Low Energy (LE)'s discoverability feature can be used for the connected device 101 to broadcast its existence. In some embodiments, the user computing device 102 can receive the wireless signal and discover the broadcasted connected device 101. In some embodiments, the wireless signal has a range.

According to some embodiments, a connection 110 can be established between the connected device 101 and the user computing device 102. The connection 110 can enable the two devices to communicate unidirectionally or bidirectionally. The connection 110 can be established by using a communication network. The communication network can be the internet and/or intranet; secured and/or non-secure; wired and/or wireless; and compatible with any type of protocols, including industry standard protocols, open source protocols, and/or proprietary protocols. In some embodiments, the connected device 101 and the user computing device 102 can connect, communicate, and transmit data amongst themselves by using a network, such as a wireless personal area network (WPAN) using, for example, Bluetooth LE.

According to some embodiments, a connection 111 can be established between the user computing device 102 and the server 103. The connection 111 can be established by using a communication network. The communication network can be the internet and/or intranet; secured and/or non-secure; wired and/or wireless; and compatible with any type of protocols, including industry standard protocols, open source protocols, and/or proprietary protocols.

According to some embodiments, a connection 112 can be established between the server 103 and the user interface 104. The connection 112 can be established by using a communication network. The communication network can be the internet and/or intranet; secured and/or non-secure; wired and/or wireless; and compatible with any type of protocols, including industry standard protocols, open source protocols, and/or proprietary protocols. For example, via the internet, the user interface 104 (e.g., the dashboard) can communicate with the server 103 to query for data, and/or the server 103 can push data to the user interface 104. In some embodiments, the user interface 104 can be accessed using a browser locally or remotely.

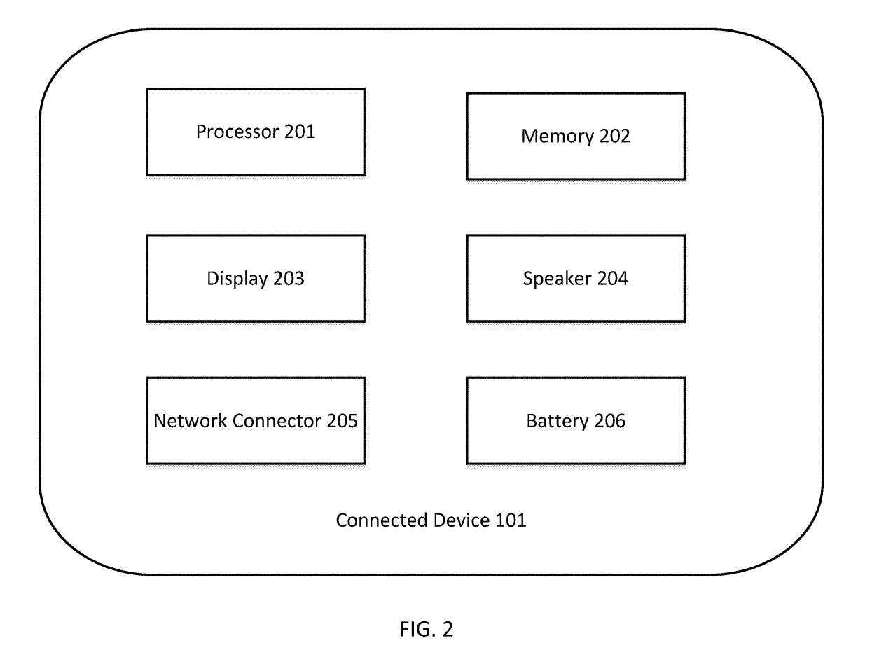

FIG. 2 illustrates a block diagram of the connected device 101 in accordance with embodiments of the present disclosure. The connected device 101 can include a processor 201, a memory 202, a display 203, a speaker 204, a network connector 205, and a battery 206. The connected device 101 can include additional components, fewer components, or any other suitable combination of components that perform any suitable operation or combination of operations described herein. In some embodiments, the connected device 101 can be a hardware device with software, including firmware, that can enable the connected device to perform its operations. For example, if the connected device 101 is a robot, the software can include instructions to move the robot. The robot can include one or more wheels, which can operate according to those instructions.

According to some embodiments, the processor 201 can be configured to implement the functionality described herein using computer executable instructions stored in the memory 202, which can be temporary and/or permanent non-transitory memory. The processor 201 can be a general purpose processor and/or can also be implemented using an application specific integrated circuit (ASIC), programmable logic array (PLA), field programmable gate array (FPGA), and/or any other integrated circuit. The processor 202 can execute an operating system (OS) that can be any suitable OS, including a typical OS, such as any version or type of Windows, Mac OS, Unix, Linux, VXWorks, Android, Blackberry OS, iOS, Symbian, or other OS.

According to some embodiments, the memory 202 can be a non-transitory computer readable medium, flash memory, a magnetic disk drive, an optical drive, a programmable read-only memory (PROM), a read-only memory (ROM), or any other memory or combination of memories.

According to some embodiments, the display 203 can include a touch screen and/or a non-touch screen. In some embodiments, the display 203 can include a liquid crystal display (LCD) or a light-emitting diode (LED) display. In some embodiments, the display 203 can include one or more lights (e.g., a LED light bulb). The display 203 can provide information about the connected device 101, information acquired by the connected device 101, and/or any other suitable information. For example, if the connected device 101 is a medical device, the display 203 can provide information about the user's health, such as the user's heart rate, temperature, blood sugar level, and/or any other suitable measurement related to the user's health. As another example, the display 203 can provide information about the status of the connected device 101, such as the operation status, the battery 206 status, the connectivity status, and/or any other suitable status. Yet in another example, the display 203 can provide information about the surrounding environment of the connected device 101, such as the environment temperature, the number of user computing devices in a given area, information received from a user computing device, and/or any other suitable information related to the surrounding environment.

According to some embodiments, the speaker 204 can provide information about the connected device 101, information stored in the memory 202, information acquired by the connected device 101, and/or any other suitable information. The speaker 204 can provide information that can be the same as and/or different from, the information provided by the display 203. For example, the speaker 204 can make a specific sound (e.g., a beeping sound) when the battery 206 is fully charged or running low; when another connected device is nearby; when a user computing device is nearby; when the number of connected devices and/or the number of user computing devices is above, below, or at a certain threshold value; and/or when a measured heart rate is above, below, or at a certain threshold value. As another example, the speaker 204 can play sound, such as music, stored in the memory 202.

According to some embodiments, the network connector 205 can enable the connected device 101 to connect to and communicate with, another device, such as a user computing device. The network connector 205 can enable wired and/or wireless connection and communication. In some embodiments, the network connector 205 can transmit wireless signals, which can be received by a user computing device and/or another network device, such as a wireless router, a cellular network device, etc. The network connector 205 can also receive wireless signals from a user computing device and/or another network device. The wireless signals can be compatible with any industry standard type (e.g., any type of the 802.11 standard, Bluetooth standard, etc.), open source type, or a proprietary type.

According to some embodiments, the battery 206 can provide power to the connected device 101. In some embodiments, the battery 206 can include a rechargeable battery and/or a disposable battery. In some embodiments, the connected device 101 can provide rechargeable power to the battery 206.

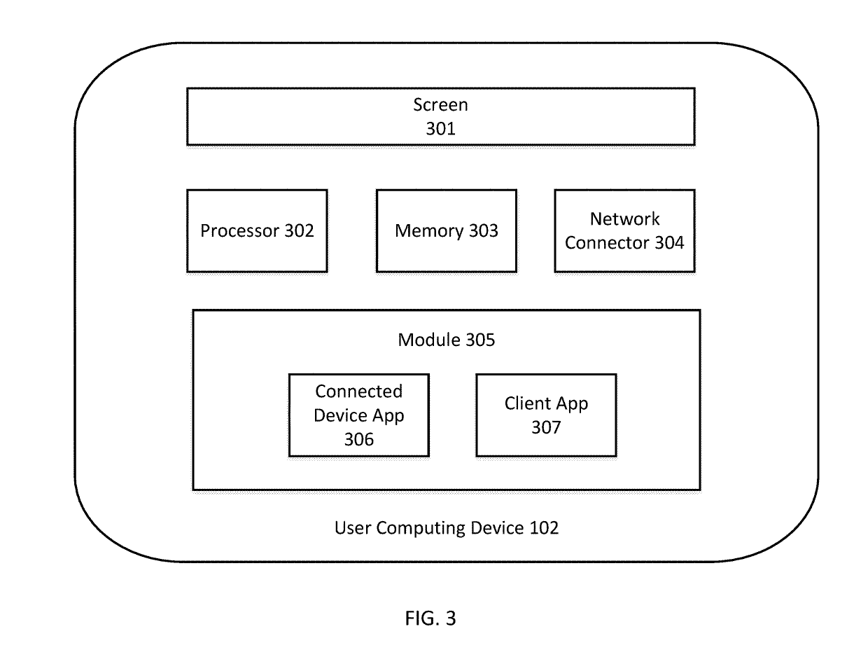

FIG. 3 illustrates a block diagram of the user connecting device 102 in accordance with embodiments of the present disclosure. The user computing device 102 can include a screen 301, a processor 302, a memory 303, a network connector 304, and a module 305. The user computing device 102 can include additional components, fewer components, or any other suitable combination of components that perform any suitable operation or combination of operations described herein. In some embodiments, the user computing device 102 can be a hardware device with software, including firmware, that can enable the user computing device 102 to perform its operations. For example, if the user computing device 102 is a smartphone, the software can include instructions to transmit data to a connected device and/or a server.

According to some embodiments, the screen 301 can be a touch screen and/or a non-touch screen. In some embodiments, the screen 301 can provide information to the user of the user computing device 102. In some embodiments, the information can include information about a connected device. The computing device 102 can acquire such information from the connected device and/or a server.

According to some embodiments, the processor 301 can be configured to implement the functionality described herein using computer executable instructions stored in the memory 303, which can be temporary and/or permanent non-transitory memory. The processor 302 can be a general purpose processor and/or can also be implemented using an application specific integrated circuit (ASIC), programmable logic array (PLA), field programmable gate array (FPGA), and/or any other integrated circuit. The processor 302 can execute an operating system (OS) that can be any suitable OS, including a typical OS such as any version or type of Windows, Mac OS, Unix, Linux, VXWorks, Android, Blackberry OS, iOS, Symbian, or other OS.

According to some embodiments, the memory 303 can be a non-transitory computer readable medium, flash memory, a magnetic disk drive, an optical drive, a programmable read-only memory (PROM), a read-only memory (ROM), or any other memory or combination of memories.

According to some embodiments, the network connector 304 can enable the user computing device 102 to connect to and communicate with, another device, such as a connected device, and/or a server. The network connector 304 can enable wired and/or wireless connection and communication. In some embodiments, the network connector 304 can transmit wireless signals, which can be received by a connected device and/or another network device, such as a wireless router, a cellular network device, etc. The network connector 304 can also receive wireless signals from a connected device and/or another network device. The wireless signals can be compatible with any industry-standard type (e.g., any type of the 802.11 standard, Bluetooth standard, etc.), open source type, or a proprietary type.

According to some embodiments, the module 305 can include a connected device application 306 and a client application 307. The connected device application 306 can be used for connecting to and communicating with, a connected device. The client application 307 can be used for connecting to and communicating with, a server. The module 305 can be configured to cause the processor 302 to execute various features associated with the module 305 that are described herein. The module 305 can be implemented as software and/or hardware. In some embodiments, the module 305 can be implemented in software using the memory 303. In some embodiments, the connected device application 306 and the client application 307 can be implemented as a single application. In other embodiments, various functions of the connected device application 306 and the client application 307 can be implemented as two or more separate applications. The module 305 can include additional applications that enable the user computing device 102 to perform operations described herein.

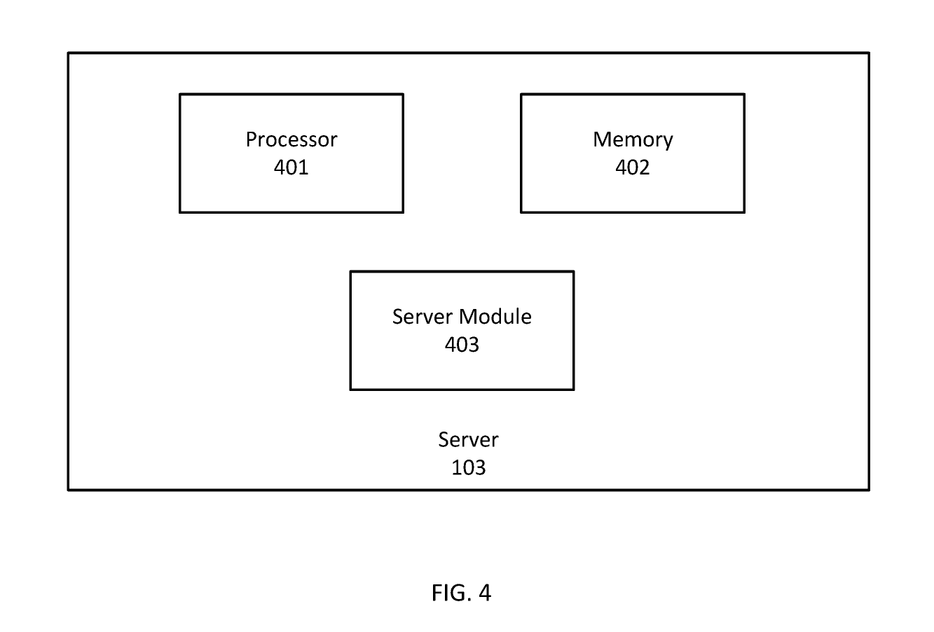

FIG. 4 illustrates a block diagram of the server 103 in accordance with some embodiments of the present disclosure. The server 103 can include a processor 401, a memory 402, and a server module 403. In some embodiments, the server 103 can communicate with a remote storage medium. The server 103 can include additional components, fewer components, or any other suitable combination of components that perform any suitable operation or combination of operations.

According to some embodiments, the processor 401 is configured to implement the functionality described herein using computer executable instructions stored in temporary and/or permanent non-transitory memory. The processor can be a general purpose processor and/or can also be implemented using an application specific integrated circuit (ASIC), programmable logic array (PLA), field programmable gate array (FPGA), and/or any other integrated circuit.

According to some embodiments, the processor 401 can execute an operating system that can be any suitable operating system (OS), including a typical operating system such as any version or type of Windows, Mac OS, Unix, Linux, VXWorks, Android, Blackberry OS, iOS, Symbian, or other OS. The processor 401 can also execute any instructions from web-server related hardware and/or software.

The memory 402 can be a non-transitory computer readable medium, flash memory, a magnetic disk drive, an optical drive, a programmable read-only memory (PROM), a read-only memory (ROM), or any other memory or combination of memories. In some embodiments, the memory 402 can include a local storage medium and/or a remote storage medium.

According to some embodiments, the server module 403 can be configured to cause the processor 401 to execute functions related to the features of the server 103 disclosed herein. For example, the server module 403 can be configured to cause the processor 401 to process requests from a user computing device. As a specific example, if a user computing device requests the server 103 to provide information regarding a connected device, the server module 403 can use the processor 401 to execute instructions to query the database (which can be part of the memory 402), determine whether a profile of the connected device exists, and provide the profile information to the user computing device if the profile exists.

According to some embodiments, the server module 403, any part of the server module 403, or any other modules or components within the server 103 can be implemented as software and/or hardware. In some embodiments, the server module 403 can be implemented in software using the memory 402.

According to some embodiments, a Universally Unique Identifier (UUID) can be assigned to a connected device to uniquely identify the connected device. For example, if a million robots are produced identically, all or a subset of those robots can be uniquely identified if they each have a UUID that is different from each other.

According to some embodiments, the UUID can be stored within the connected device. For example, the UUID can be stored as part of firmware, which can be installed on the processor 201 (FIG. 2) and/or the memory 202 (FIG. 2) of the connected device during manufacturing. In some embodiments, if the connected device is new, the connected device's UUID value in the firmware can be set to a null value. When a user computing device first connects to the connected device 101 via a communication protocol (e.g., Bluetooth, WiFi, or any other suitable wireless communication protocol), the connected device application 306 (FIG. 3) on the user computing device can generate a UUID. The connected device application 306 can then save the UUID onto the connected device 101. In some embodiments, the connected device application 306 can also request to create and store a profile of the connected device 101 with that UUID on the server 103. The profile can be used to save any other data that the user computing device 102, the server 103, or any other suitable device or system desires to associate with the connected device 101. For example, the profile can be used to save data including a human-readable name of the connected device 101, a description of the connected device 101, the manufacturing date of the connected device 101, the initialization date of the connected device 101, the firmware version of the connected device 101, and/or any other suitable data that can be associated with the connected device 101.

According to some embodiments, after the connected device 101 has been assigned a UUID, it can broadcast its existence with the UUID to user computing devices. In some embodiments, if the network connector 205 (FIG. 2) of the connected device 101 is using Bluetooth LE, the UUID can be added to the Bluetooth LE's standard advertising packet for broadcasting. In some embodiments, if another user computing device, which is not the original connecting device, sees the connected device 101, this other user computing device can search the advertised UUID on the server 103 and fetch the profile of the connected device 101 from the server 103.

Accordingly, disclosed systems, methods, and media enable the connected device 101 to have a unique profile and data associated with the profile that are not related to any specific user computing device. In some embodiments, the profile and data associated with the profile can be accessible by any connecting user computing device, regardless of the connecting user computing device's knowledge of the original connecting user computing device. Moreover, a user computing device can determine whether a connected device has a UUID even without network access to the server 103. Based on this determination, the user computing device can determine whether the connected device may belong to some other user-in which case, the connected device would not be available to be initialized with a new UUID.

According to some embodiments, UUIDs can be managed centrally. For example, all UUIDs may be required to be registered at a central location (e.g., the server 103). Such a central UUID managing system can guarantee the uniqueness of each of the UUIDs. In some embodiments, UUIDs may be managed locally. For example, a user computing device can create a UUID without registering at a central location. In this case, a UUID can be created using a mathematical formula to produce a probabilistically unique value (e.g., a 128-bit value created with random bytes to conform to RFC 4122 version). This system may not fully guarantee the uniqueness of the UUID. By using probabilistically unique values for UUIDs, UUIDs can be generated without server interaction. This can be useful if the user computing device 102 is in an offline mode, as a UUID can be created with a reduced risk of duplicating an existing UUID on the server 103. In addition, this can help avoid an exhaustive search of the existing profiles on the server 103. In some embodiments, the risk of duplicating an existing UUID can be reduced to virtually nil.

According to some embodiments, offline-generated UUID and data associated with the UUID can be synchronized on the server 103 at a later time, when the user computing device 102 connects to the server 103. The synchronization can be automatic (e.g., upon establishing any connection) and/or manual (e.g., upon the user's execution of the synchronization command). In some embodiments, if the UUID has not been synchronized with the server 103, then the connected device 101 with an offline-created UUID will not appear as available to other user computing devices. In other embodiments, even if the UUID has not been synchronized with the server 103, the connected device 101 with an offline-created UUID can be available to other user computing devices but these other user computing devices may not access any other data associated with the connected device 101. In some embodiments, data associated with the connected device 101 may never become synchronized with the server 103.

According to some embodiments, a UUID can be assigned to the connected device 101 before the connected device is 101 is delivered to its user. For example, a probabilistically unique UUID can be assigned to the connected device 101 during manufacturing. This can negate the need for the user computing device 101 to generate and save the UUID. In some embodiments, the UUID of the connected device 101 can be reset, such that the user computing device 102 can assign a new UUID to the connected device 101. The UUID can be reset by the connected device 101 and/or the user computing device 102.

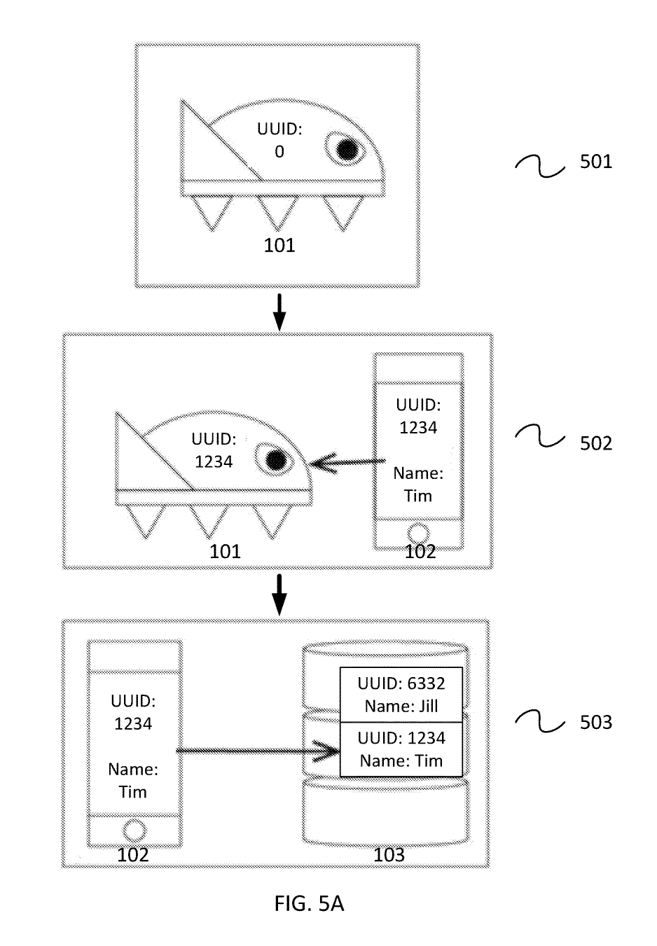

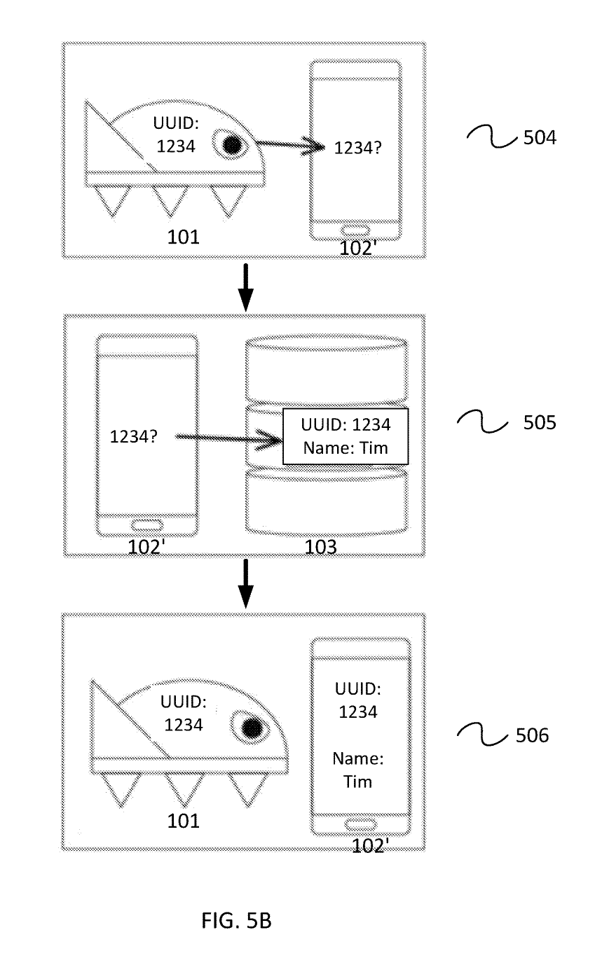

FIGS. 5A-5B illustrate a method of generating, assigning, and sharing a UUID in accordance with embodiments of the present disclosure. In some embodiments, the method can be modified by, for example, having steps combined, divided, rearranged, changed, added, and/or removed.

At step 501 in FIG. 5A, the connected device 101 with an unassigned UUID can broadcast its existence. In some embodiments, the unassigned UUID can have a null value. In some embodiments, the null value can be indicated by assigning the numerical value of zero (“0”) to the corresponding variable that stores the UUID in the firmware of the connected device 101. In some embodiments, the connected device 101 can have such an unassigned UUID if the connected device is new, or if the connected device previously had an assigned UUID value but the assigned UUID value has been reset.

According to some embodiments, the connected device 101 can broadcast its unassigned UUID value (e.g., the null value). The user computing device 102 can receive the broadcasted UUID of the connected device 101. In some embodiments, the user computing device 102 can establish a connection with the connected device 101. Based on the broadcasted unassigned UUID value of the connected device 101, the user computing device 102 can determine that no UUID has been assigned to the connected device 101.

At step 502 in FIG. 5A, the user computing device 102 can generate a UUID and assign it to the connected device 101. For example, the user computing device 102 can generate a numerical value of “1234” as the UUID. The user computing device 102 can transmit the generated UUID to the connected device 101. The connected device 101 can receive the generated UUID and set its UUID as the generated UUID. For example, the previously-set UUID value of “0” can be replaced with the generated-UUID value of “1234.” In some embodiments, the user computing device 102 can generate—automatically and/or manually—other data associated with the connected device 101. For example, the user of the user computing device 102 can decide to give a name (e.g., “Tim”) to the connected device 101. In some embodiments, some or all of the other data associated with the connected device 101 can be transmitted to the connected device 101. In other embodiments, none of the other data associated with the connected 101 can be transmitted to the connected device 101.

At step 503 in FIG. 5A, the user computing device 102 can create a profile of the connected device 101 with the generated UUID (e.g., “1234”) on the server 103. In some embodiments, the user computing device 102 can also save any other data associated with the connected device 101. For example, the user computing device 102 can save the name of the user computing device 102 (e.g., “Tim”) and associate the name with the generated UUID on the server 103.

At step 504 in FIG. 5B, the connected device 101 can broadcast its newly-assigned UUID of “1234.” A second user computing device 102′ can receive this UUID and connect to the connected device 101. In some embodiments, the second user computing device 102′ can be different from the user computing device 102. At this point, the second user computing device 102′ can determine that the connected device 101 has an assigned UUID based on the value of the received UUID. The second user computing device 102′ can additionally determine that the connected device 101 may belong to someone. However, the second user computing device 102′ may not have any other information about the connected device 101 at this point.

At step 505 in FIG. 5B, the second user computing device 102′ can connect to the server 103 and query the server 103 with the UUID that was received from the connected device 101. The server 103 can retrieve the profile of the connected device 101 based on the UUID.

At step 506 in FIG. 5B, the second user computing device 102′ can receive data associated with the profile of the connected device 101 from the server 103. For example, the second user computing device 102′ can receive the name of the connected device 101 (e.g., “Tim”). In some embodiments, data associated with the profile can include public data and/or private data. In some embodiments, the server 103 can provide only the public data to a user computing device. In some embodiments, names and descriptions of connected devices can be public data. In some embodiments, a server administrator can configure data types for data associated with connected devices.

According to some embodiments, the connected device 101 can collect data. The data can include information about the connected device 101, information about other devices, information about the surrounding environment, and/or any other suitable information that can be collected by the connected device 101. For example, a robot, which is a connected device, can collect information, such as usage time, playtime, distance travelled, robot sensor data, games played, actions performed, and/or any other suitable information.

According to some embodiments, the connected device 101 can include a sensor, and the connected device 101 can collect information using the sensor. In some embodiments, the sensor can be one or more of the following sensor types: an accelerometer, a visible light sensor, or an infrared (IR) signal sensor. For example, if the robot has an IR signal sensor, the data collected can include messages transmitted to the robot via IR light. In some embodiments, these IR messages can have a specific definition that provides information about the state of the robot. For example, in one configuration, a received IR message can indicate that the robot was “hit” by IR light transmitted by another robot during a game of laser tag. This information can then be stored on the robot and eventually be transmitted to the server 103 via the user computing device 102. The server 103 can update the robot's profile to indicate that the robot received a hit command by another robot. IR messages can include any other suitable information or combination of information that may be relevant to a game. In some embodiments, none of this data is personal because it is not associated with a user account or a particular user computing device. Moreover, such data may not contain any data that can be linked to a specific user, a specific user computing device, a user's location, and/or any other personally-identifiable information. Thus, it can be safe to provide such information publicly on the server 103 without restriction.

According to some embodiments, it can be desirable to determine what or how many devices have connected to the connected device 101. In some embodiments, this can be achieved by tracking users and/or user computing devices. For example, the server 103 can keep track of user computing devices that have connected to the server 101 for the connected device 101. In some embodiments, the server 103 can require each user computing device to log in with a user name to the server 103 before being able to access information on the server 103. The server 103 can then keep track of the user names that have logged in to access the profile of the connected device 101. In some embodiments, such information about the user computing devices and/or user names can be associated with the profile of the connected device 101. In some embodiments, a reverse lookup can be performed such that given a specific connected device, a list of users and/or user computing devices that have connected to the specific connected device can be queried and retrieved.

According to some embodiments, performance of the connected device 101 can be tracked over time. In some embodiments, data points and/or metrics over time can be analyzed based on information collected by the connected device 101. Certain trigger points can be set based on various types of events to notify the user and/or prompt the user to perform an action. In some embodiments, the connected device 101 can be monitored for usage (e.g., a distance a robot has driven, a number of times a heart rate monitor has measured heart rates). Certain milestones related to the usage can be configured and monitored. For example, after a robot has traveled for 1000 meters or any other suitable distance, the user can be notified of the distance travelled via the user computing device. The user can also be prompted to take an action, such as a maintenance check or any other suitable action. The user can also be asked whether the robot is performing normally. In these embodiments, the connected device is being tracked instead of the user computing device; thus, any privacy concerns relating to tracking user computing devices can be eliminated. In some embodiments, the disclosed tracking mechanisms can be particularly useful for devices (e.g., Bluetooth beacons in a store) that are connected by many users, as those devices can provide valuable information to their users seamlessly.

According to some embodiments, analytics data from connected devices can be combined with analytics data from user computing devices. For example, in the context of a connected toy robot controlled by personal devices, interactions between the toy robots can be used to coordinate gaming and keep scoring unique to a robot, despite multiple robots being present or connected to multiple personal devices simultaneously. Location or proximity data collected from the personal devices can be used to coordinate such actions more seamlessly.

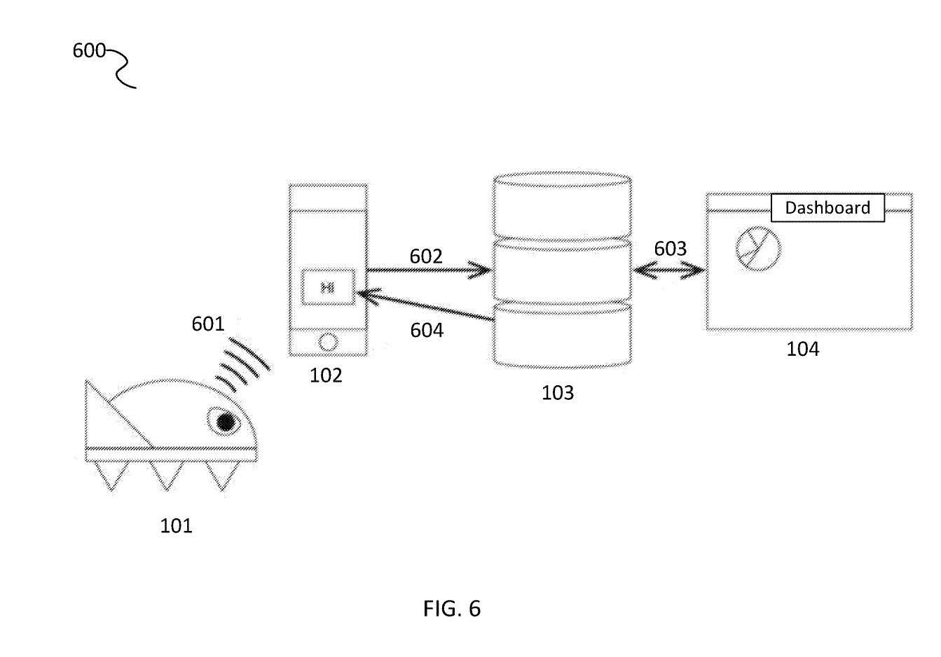

FIG. 6 illustrates analytics network architecture 600 and a related method in accordance with embodiments of the present disclosure. The analytics network 600 can include the connected device 101, the user computing device 102, the server 103, and the user interface 104. In some embodiments, the method can be modified by, for example, having steps combined, divided, rearranged, changed, added, and/or removed.

At step 601, the connected device 101 can transmit its assigned UUID and data including its collected information (e.g., sensor data collected using a sensor). The user computing device 102 can receive the transmitted UUID and the transmitted data. For example, the connected device 101 can transmit its acceleration data to the user computing device 102. In some embodiments, the acceleration data of a robot can be tracked over a period of time to estimate the robot's distance travelled (i.e., displacement) during that period of time. In some embodiments, the user computing device 102 can aggregate, interpret, and/or process the data transmitted from the connected device 101.

At step 602, the user computing device 102 can send the UUID of the connected device 101 and some or all of the data transmitted from the connected device 101 to the server 103. In some embodiments, the user computing device 102 can send aggregated, interpreted, and/or processed data to the server 103. For example, the connected device 101 can send information about a distance it travels to the user computing device 102 every one minute. The user computing device 102 can add the distances sent by the connected device 101 over a period of ten minutes and send the sum of the distances to the server 103 every ten minutes. In some embodiments, the server 103 can instead perform the aggregation, interpretation, and/or processing of data.

According to some embodiments, the server 103 can log data over time from one or more connected devices (e.g., multiple robots). The server 103 can use the data to calculate related data. For example, the server 103 can calculate the average distance travelled in a day's sessions for a robot. As another example, the server 103 can calculate the average distance travelled in a week's sessions for a group of robots that belong to a particular demographic group.

At step 603, the user interface 104 (e.g., a dashboard) can communicate with the server 103. In some embodiments, the user interface 104 can query for specific analytics data, such as data belonging to specific dates or range of dates. For example, the dashboard can query for the average distance traveled for a particular robot per session from May 14 to May 30.

Using the data received from the server 103, the dashboard can display the information. In some embodiments, the dashboard can provide visualizations of the received data. For example, the dashboard can draw a pie graph showing a number of percentages, where the whole pie represents the total distance travelled by a group of robots, and each percentage represents a percentage of the total distance travelled by each robot in the group. As another example, the dashboard can draw a line graph showing the average distance traveled per session across specific dates or range of dates.

At step 604, the server 103 can be configured to push information or send requests to the user computing device 102 based on data logs on the server 103. For example, the server 103 can send a notification, an alert, and/or a survey to the user computing device 102 when the connected device 101 has travelled a distance that exceeds a specific threshold.

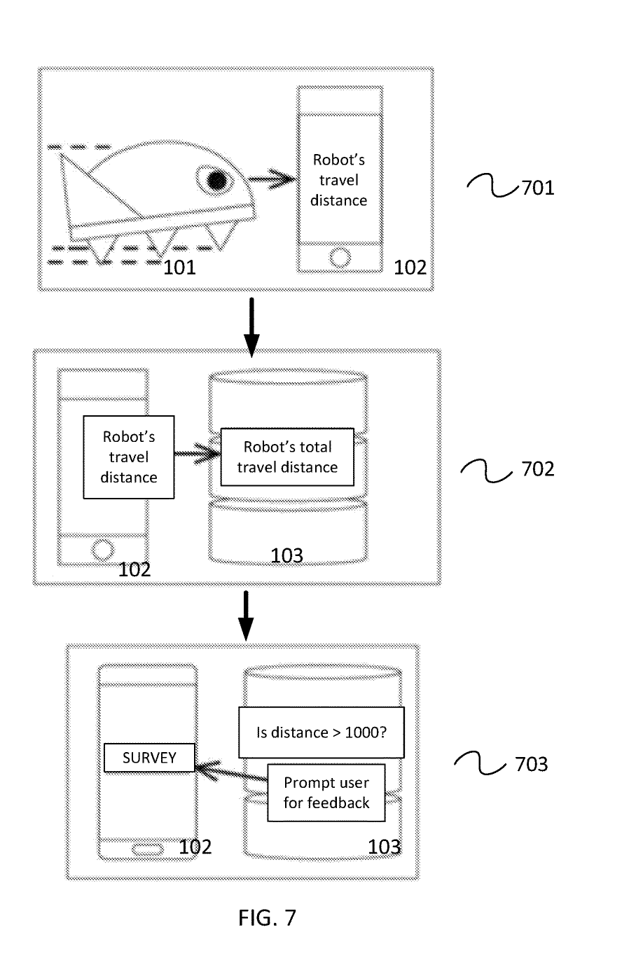

FIG. 7 illustrates a method of using connected device data to solicit event-triggered feedback from the user. In some embodiments, the method can be modified by, for example, having steps combined, divided, rearranged, changed, added, and/or removed.

At step 701, the connected device 101 can run forward and report data from its motion sensor(s) to the user computing device 102.

At step 702, the user computing device 102 can use the received motion data from the connected device 101 to estimate the distance the connected device 101 has travelled. The user computing device 102 can then send the estimated distance to the server 103 that tracks the total distance travelled by the connected device 101. The server 103 can associate the total distance travelled by the connected device 101 with the profile of the connected device 101 on the server 103.

At step 703, when the total distance travelled by the connected device 101 becomes greater than 1000 feet or any other suitable distance, the server 103 can request the user computing device 102 to prompt the user for feedback. The feedback can be about the robot in the form of a survey. In some embodiments, the server 103 can push the request to the user's computing device 102 using a push notification and/or any other suitable service. The user of the user computing device 102 can then decide to respond to the survey. If the user responds, the user computing device 102 can send the response to the server 103. FIG. 7 is not restricted to using a single user computing device. For example, multiple user computing devices can track the distances travelled by the connected device 101 at different times and send relevant data to the server 103. The server 103 can then aggregate the data sent by those user computing devices.

According to some embodiments, the connected device 101 can be coupled to an accessory. An accessory can add or modify a feature of the connected device 101. For example, an accessory for a robot can be a face that replaces the existing face of the robot. As another example, an accessory for a heart rate monitor can be a new strap.

According to some embodiments, data associated with an accessory can be tracked by associating the accessory with the connected device 101. The data associated with the accessory can be saved to the profile of the connected device 101, to which the accessory is coupled. For example, a unique code (e.g., a Quick Response (QR) code, a barcode, or any other suitable code) can be associated with an accessory by placing the unique code on the accessory. The user computing device 102 can be used to scan the code. For example, an application, such as the connected device app 306 (FIG. 3), on the user computing device 102 can use the camera to scan the code. When the code is scanned, the application can create a UUID of the accessory based on the code and save the UUID of the accessory to the profile of the connected device 101. The accessory can now be associated with the connected device 101.

According to some embodiments, the accessory's association with the connected device 101 is independent of the user computing device 102. If another user computing device attempts to scan the same accessory code, the application of that other computing device can search the server and retrieve the profile, with which the accessory is associated. In some embodiments, information about the accessory can be retrieved from the server 103 and used to take an action within the application.

According to some embodiments, accessories can be purchased, sold, and/or traded. For example, a first user may have a green hat as an accessory for a first robot. A second user may purchase the green hat from the first user—either online or offline—and place the green hat on a second robot. The application of the first user can release the association of the green hat with the profile of the first robot. The application of the second user can then associate the green hat with the profile of the second robot.

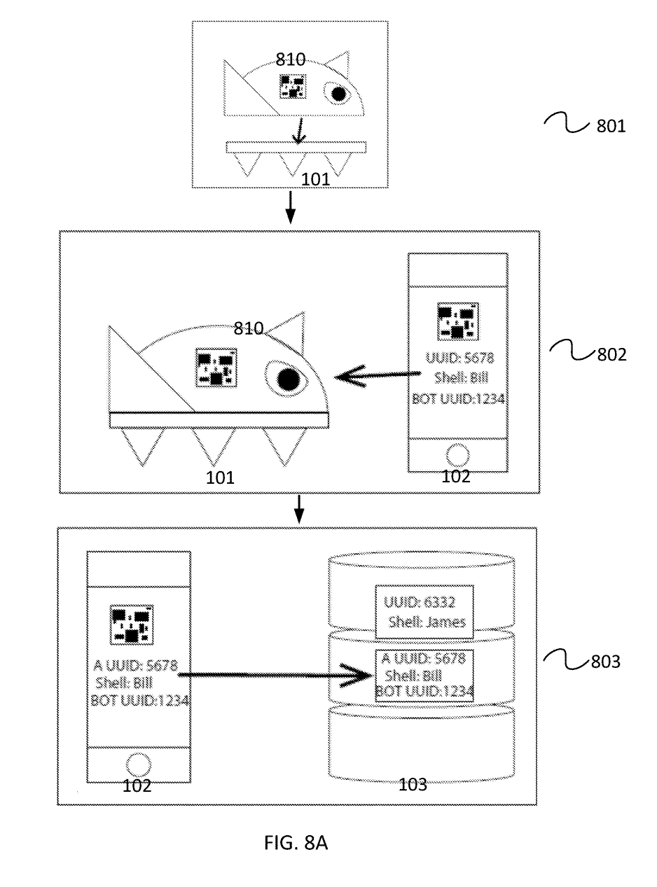

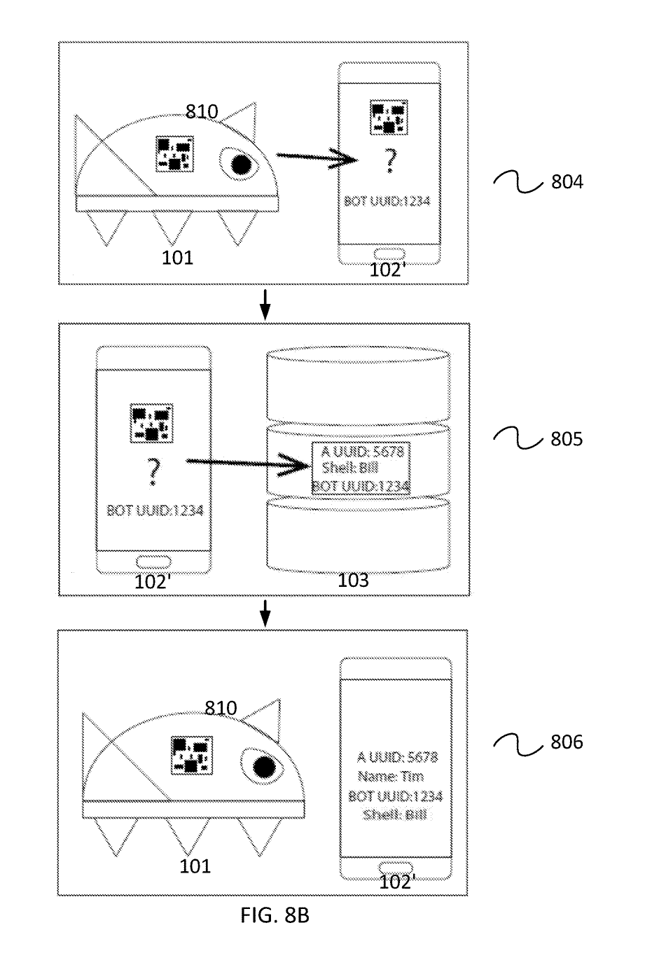

FIGS. 8A-8B illustrate a method of tracking an accessory in accordance with embodiments of the present disclosure. In some embodiments, the method can be modified by, for example, having steps combined, divided, rearranged, changed, added, and/or removed.

According to some embodiments, the connected device 101 can have its shell replaced with an accessory shell 810. For example, at step 801 in FIG. 8A, a user can mechanically attach the accessory shell 810 to the connected device 101. The accessory shell 810 can have a QR code.

At step 802 in FIG. 8A, the user computing device 102 can scan the QR code on the accessory shell 810 with the camera. The user computing device 102 can generate a UUID for the accessory shell 810 based on the QR code. For example, the UUID of the accessory shell can be generated as “5678.” The accessory shell 810 can also be named. For example, the name of the accessory shell 810 can be named “Bill.” The user computing device 102 can also receive the UUID of the connected device 101. For example, the UUID of the connected device 101 can be “1234.”

At step 803 in FIG. 8A, the user computing device 102 can connect to the server 103 to save the UUID of the accessory shell 810 and associate the UUID of the accessory shell 810 with the profile of the connected device 101. The user computing device 102 can also save other data associated with the accessory shell 810 on the server 103. For example, the name “Bill” can also be saved on the server 103 and associated with the profile of the connected device 101. Thus, the server 103 can associate the UUID of the accessory shell 810 (i.e., “5678”) and the name of the accessory shell 810 (i.e., “Bill”) with the profile of the connected device 101, which has its own UUID of “1234.”

At step 804 in FIG. 8B, a second user computing device 102′ can connect to the connected device 101 and determine that the UUID of the connected device 101 is “1234.” The second user computing device 102′ can also scan the QR code on the accessory shell 810. At this point, the second user computing device 102′ does not have any other information about the accessory shell 810.

At step 805 in FIG. 8B, the second user computing device 102′ can query the server 103 with the QR code scanned from the accessory shell 810 and search for the profile of the connected device 101 that is associated with the accessory shell 810. The second user computing device 811 can also look up any other information associated with the accessory shell 810.

At step 806 in FIG. 8B, the second user computing device 102′ can retrieve public data associated with the accessory shell 810 from the server 103. For example, the UUID and the name of the accessory shell 810 can be public data. After the second user computing device 102′ retrieves the public data, the second user computing device 102′ can recognize that the UUID of the accessory shell 810 is “5678” and that the name of the accessory shell 810 is “Bill.” The second user computing device 102′ can also recognize that the accessory shell 810 is associated with a profile of a certain connected device and assume that the accessory shell 810 is owned by someone. In some embodiments, the second user computing device 102′ can act on the received data related to the accessory shell 810. For example, the second user computing device 102′ may be collecting and analyzing data related to accessory names. Thus, the second user computing device 102′ can add the name “Bill” to its own private database for its analysis.

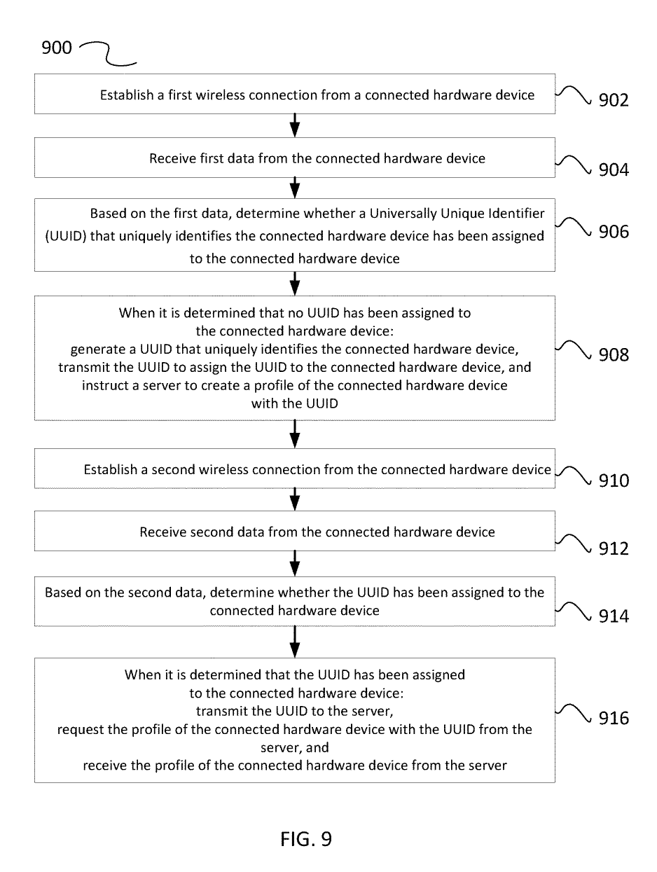

FIG. 9 illustrates a method 900 of tracking a connected hardware device in accordance with embodiments of the present disclosure. In some embodiments, the method 900 can be modified by, for example, having steps combined, divided, rearranged, changed, added, and/or removed.

At step 902, a first wireless connection from a connected hardware device can be established at a first user computing device. In some embodiments, the connected hardware device can be a medical device, an appliance, a wireless heart rate monitor, a smart toy, a wireless webcam, and/or any other suitable device.

At step 904, first data from the connected hardware device can be received at the first user computing device.

At step 906, the first user computing device can determine whether a UUID that uniquely identifies the connected hardware device has been assigned to the connected hardware device based on the first data.

At step 908, when it is determined that no UUID has been assigned to the connected hardware device, the first user computing device can generate a UUID that uniquely identifies the connected hardware device; transmit the UUID to the connected hardware device to assign the UUID to the connected hardware device; and instruct a server to create a profile of the connected hardware device with the UUID. In some embodiments, the first user computing device can also instruct the server to create the profile based on third data including user-created data, a name, a description, an initialization date, a firmware version, and/or any other suitable data. In some embodiments, the UUID can be a probabilistically unique value.

At step 910, a second user computing device can establish a second wireless connection from the connected hardware device. In some embodiments, the second user computing device can be the same or different as the first user computing device.

At step 912, the second user computing device can receive second data from the connected hardware device.

At step 914, the second user computing device can determine whether the UUID has been assigned to the connected hardware device based on the second data.

At step 916, when it is determined that the UUID has been assigned to the connected hardware device, the second user computing device can transmit the UUID to the server; request the profile of the connected hardware device with the UUID from the server; and receive the profile of the connected hardware device from the server. In some embodiments, the second user computing device can receive third data including information collected by, and relating to, the connected hardware device—from the connected hardware device. In some embodiments, the collected information can include a usage time, a distance travelled, sensor data, one or more games played, one or more actions performed, and/or any other suitable collected information. In some embodiments, the second user computing device can transmit the collected information to the server. In some embodiments, the second user computing device can instruct the server to update the profile of the connected hardware device with the collected information. In some embodiments, the first or the second user computing device can receive a notification regarding the connected hardware device from the server. In some embodiments, the first or the second user computing device can retrieve—from an accessory coupled to the connected hardware device—a unique accessory code that has not been associated with any connected hardware device on the server; generate a second UUID for the accessory based on the unique accessory code; and instruct the server to associate the accessory with the connected hardware device based at least on the UUID and the second UUID.

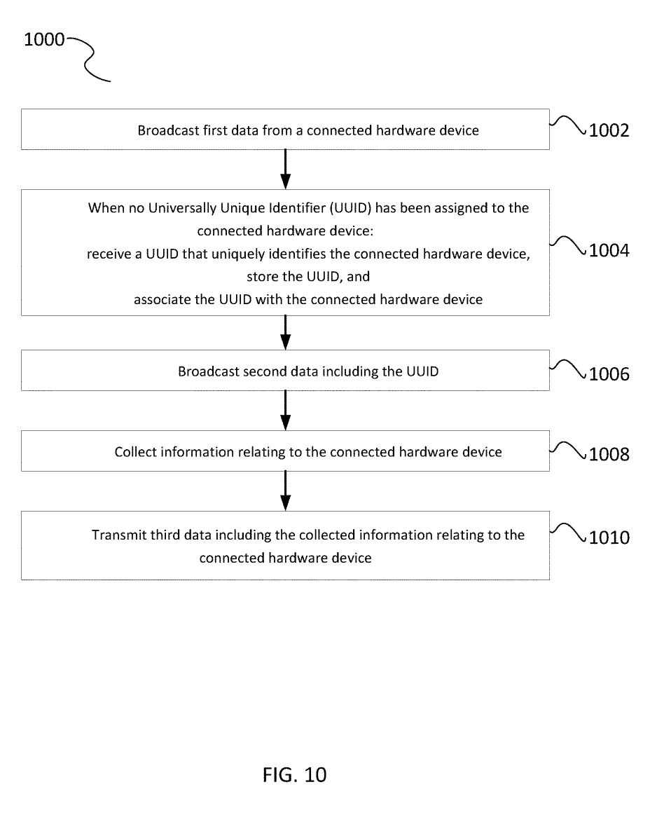

FIG. 10 illustrates a method 1000 of tracking a connected hardware device in accordance with embodiments of the present disclosure. In some embodiments, the method 1000 can be modified by, for example, having steps combined, divided, rearranged, changed, added, and/or removed.

At step 1002, a connected hardware device can broadcast first data.

In some embodiments, the connected hardware device is a medical device, an appliance, a wireless heart rate monitor, a smart toy, a wireless webcam, and/or any other suitable device.

At step 1004, when no UUID has been assigned to the connected hardware device, the connected hardware device can receive a UUID that uniquely identifies the connected hardware device from a first user computing device; store the UUID; and associate the UUID with the connected hardware device.

At step 1006, the connected hardware device can broadcast second data including the UUID.

At step 1008, the connected hardware device can collect information relating to the connected hardware device. In some embodiments, the connected hardware device can collect the information from a sensor(s). In some embodiments, the sensor(s) can include an accelerometer, a visible light sensor, an infrared signal sensor, and/or any other suitable sensor.

At step 1010, the connected hardware device can transmit third data including the collected information relating to the connected hardware device to a second user computing device. In some embodiments, the second user computing device can be the same or different as the first user computing device. In some embodiments, the collected information can include a usage time, a distance travelled, sensor data, one or more games played, one or more actions performed, and/or any other suitable information.

According to some embodiments, access control can be implemented for accessing connected devices and/or accessing data associated with connected devices. For example, a user account can be necessary for a user computing device to access a certain connected device. The user account can be saved with the profile of the connected device. When the user computing device connects to the connected device, the user computing device can be prompted for authentication information (e.g., a username and/or a password). The authentication information can be stored with the profile of the connected device on the server. In some embodiments, the user computing device can further communicate with the connected device only after the user computing device has provided the correct authentication information.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method of tracking a connected hardware device, comprising:
establishing, at a first user computing device, a first wireless connection from a connected hardware device;
receiving, at the first user computing device, first data from the connected hardware device;
based on the first data, determining, at the first user computing device, whether a Universally Unique Identifier (UUID) that uniquely identifies the connected hardware device has been assigned to the connected hardware device;
when it is determined that no UUID has been assigned to the connected hardware device:
generating, at the first user computing device, a UUID that uniquely identifies the connected hardware device,
transmitting, from the first user computing device to the connected hardware device, the UUID to assign the UUID to the connected hardware device, and
instructing, by the first user computing device, a server to create a profile of the connected hardware device with the UUID;
establishing, at a second user computing device, a second wireless connection from the connected hardware device;
receiving, at the second user computing device, second data from the connected hardware device;
based on the second data, determining, at the second user computing device, whether the UUID has been assigned to the connected hardware device; and
when it is determined that the UUID has been assigned to the connected hardware device:
transmitting, from the second user computing device to the server, the UUID,
requesting, from the server by the second user computing device, the profile of the connected hardware device with the UUID, and
receiving, at the second user computing device from the server, the profile of the connected hardware device.

2. The method of claim 1, wherein the second user computing device can be the same or different as the first user computing device.

3. The method of claim 1, wherein when it is determined that no UUID has been assigned to the connected hardware device, instructing, by the first user computing device, the server to create the profile based on third data comprising at least one of user-created data, a name, a description, an initialization date, or a firmware version.

4. The method of claim 1, further comprising receiving, at the second user computing device from the connected hardware device, third data comprising information collected by, and relating to, the connected hardware device.

5. The method of claim 4, wherein the collected information comprises at least one of a usage time, a distance travelled, sensor data, one or more games played, or one or more actions performed.

6. The method of claim 4, further comprising:
transmitting, from the second user computing device to the server, the collected information; and
instructing, by the second user computing device, the server to update the profile of the connected hardware device with the collected information.

7. The method of claim 1, wherein the UUID is a probabilistically unique value.

8. The method of claim 1, further comprising receiving, at the first or the second user computing device from the server, a notification regarding the connected hardware device.

9. The method of claim 1, further comprising:
retrieving, at the first or the second user computing device from an accessory coupled to the connected hardware device, a unique accessory code that has not been associated with any connected hardware device on the server;
generating, at the first or the second user computing device, a second UUID for the accessory based on the unique accessory code;
instructing, by the first or the second user computing device, the server to associate the accessory with the connected hardware device based at least on the UUID and the second UUID.

10. The method of claim 1, wherein the connected hardware device is one of a medical device, an appliance, a wireless heart rate monitor, a smart toy, or a wireless webcam.

11. A method of tracking a connected hardware device, comprising:
broadcasting, from a connected hardware device, first data from the connected hardware device;
when no Universally Unique Identifier (UUID) has been assigned to the connected hardware device:
receiving, at the connected hardware device from a first user computing device, a UUID that uniquely identifies the connected hardware device,
storing, at the connected hardware device, the UUID, and
associating, at the connected hardware device, the UUID with the connected hardware device;
broadcasting, from the connected hardware device, second data including the UUID;
collecting, by the connected hardware device, information relating to the connected hardware device; and
transmitting, from the connected hardware device to a second user computing device, third data including the collected information relating to the connected hardware device.

12. The method of claim 11, wherein the second user computing device can be the same or different as the first user computing device.

13. The method of claim 11, further comprising collecting, by the connected hardware device, the information from one or more sensors.

14. The method of claim 13, wherein the one or more sensors comprise at least one of an accelerometer, a visible light sensor, or an infrared signal sensor.

15. The method of claim 11, wherein the collected information includes at least one of a usage time, a distance travelled, sensor data, one or more games played, or one or more actions performed.

16. The method of claim 11, wherein the connected hardware device is one of a medical device, an appliance, a wireless heart rate monitor, a smart toy, or a wireless webcam.

17. A user computing device, comprising:
a memory that stores a module; and
a processor configured to run the module stored in the memory that is configured to cause the processor to:
establish a first wireless connection from a connected hardware device;
receive first data from the connected hardware device;
based on the first data, determine whether a Universally Unique Identifier (UUID) that uniquely identifies the connected hardware device has been assigned to the connected hardware device;
when it is determined that no UUID has been assigned to the connected hardware device:
generate a UUID that uniquely identifies the connected hardware device,
transmit the UUID to the connected hardware device to assign the UUID to the connected hardware device, and
instruct a server to create a profile of the connected hardware device with the UUID;
establish a second wireless connection from the connected hardware device;
receive second data from the connected hardware device;
based on the second data, determine whether the UUID has been assigned to the connected hardware device; and
when it is determined that the UUID has been assigned to the connected hardware device:
transmit the UUID to the server,
request the profile of the connected hardware device with the UUID from the server, and
receive the profile of the connected hardware device from the server.

18. The user computing device of claim 17, wherein the processor is further configured to run the module stored in the memory that is configured to cause the processor to:
when it is determined that no UUID has been assigned to the connected hardware device, instruct the server to create the profile based on third data comprising at least one of user-created data, a name, a description, an initialization date, or a firmware version.

19. The user computing device of claim 17, wherein the processor is further configured to run the module stored in the memory that is configured to cause the processor to:
receive third data comprising information collected by, and relating to, the connected hardware device from the connected hardware device;
transmit the collected information to the server; and
instruct the server to update the profile of the connected hardware device with the collected information.

20. The user computing device of claim 17, wherein the UUID is a probabilistically unique value.

21. The user computing device of claim 17, wherein the processor is further configured to run the module stored in the memory that is configured to cause the processor to:
receive a notification regarding the connected hardware device from the server.

22. The user computing device of claim 17, wherein the processor is further configured to run the module stored in the memory that is configured to cause the processor to:
retrieve, from an accessory coupled to the connected hardware device, a unique accessory code that has not been associated with any connected hardware device on the server;
generate a second UUID for the accessory based on the unique accessory code; and
instruct the server to associate the accessory with the connected hardware device based at least on the UUID and the second UUID.

23. A connected hardware device, comprising:
a memory that stores a module; and
a processor configured to run the module stored in the memory that is configured to cause the processor to:
broadcast first data from the connected hardware device;
when no Universally Unique Identifier (UUID) has been assigned to the connected hardware device:
receive a UUID that uniquely identifies the connected hardware device from a first user computing device,
store the UUID, and
associate the UUID with the connected hardware device;
broadcast second data including the UUID;
collect information relating to the connected hardware device; and
transmit third data including the collected information relating to the connected hardware device to a second user computing device.

24. The connected hardware device of claim 23, wherein the second user computing device can be the same or different as the first user computing device.

25. The connected hardware device of claim 23, wherein the processor is further configured to run the module stored in the memory that is configured to cause the processor to:
collect the information from one or more sensors.

26. The connected hardware device of claim 23, wherein the collected information includes at least one of a usage time, a distance travelled, sensor data, one or more games played, or one or more actions performed.

27. The connected hardware device of claim 23, wherein the connected hardware device is one of a medical device, an appliance, a wireless heart rate monitor, a smart toy, or a wireless web cam.

28. A non-transitory computer readable medium having executable instructions operable to cause an apparatus to:
establish a first wireless connection from a connected hardware device;
receive first data from the connected hardware device;
based on the first data, determine whether a Universally Unique Identifier (UUID) that uniquely identifies the connected hardware device has been assigned to the connected hardware device;
when it is determined that no UUID has been assigned to the connected hardware device:
generate a UUID that uniquely identifies the connected hardware device,
transmit the UUID to the connected hardware device to assign the UUID to the connected hardware device, and
instruct a server to create a profile of the connected hardware device with the UUID;
establish a second wireless connection from the connected hardware device;
receive second data from the connected hardware device;
based on the second data, determine whether the UUID has been assigned to the connected hardware device; and
when it is determined that the UUID has been assigned to the connected hardware device:
transmit the UUID to the server,
request the profile of the connected hardware device with the UUID from the server, and
receive the profile of the connected hardware device from the server.

29. The non-transitory computer readable medium of claim 28 further having executable instructions operable to cause the apparatus to:
when it is determined that no UUID has been assigned to the connected hardware device, instruct the server to create the profile based on third data comprising at least one of user-created data, a name, a description, an initialization date, or a firmware version.

30. The non-transitory computer readable medium of claim 28 further having executable instructions operable to cause the apparatus to:
receive third data comprising information collected by, and relating to, the connected hardware device from the connected hardware device;
transmit the collected information to the server; and
instruct the server to update the profile of the connected hardware device with the collected information.

31. The non-transitory computer readable medium of claim 28, wherein the UUID is a probabilistically unique value.

32. The non-transitory computer readable medium of claim 28 further having executable instructions operable to cause the apparatus to:
retrieve, from an accessory coupled to the connected hardware device, a unique accessory code that has not been associated with any connected hardware device on the server;
generate a second UUID for the accessory based on the unique accessory code; and
instruct the server to associate the accessory with the connected hardware device based at least on the UUID and the second UUID.

33. A non-transitory computer readable medium having executable instructions operable to cause an apparatus to:
broadcast first data from a connected hardware device;
when no Universally Unique Identifier (UUID) has been assigned to the connected hardware device:
receive a UUID that uniquely identifies the connected hardware device from a first user computing device,
store the UUID, and
associate the UUID with the connected hardware device;
broadcast second data including the UUID;
collect information relating to the connected hardware device; and
transmit third data including the collected information relating to the connected hardware device to a second user computing device.

34. The non-transitory computer readable medium of claim 33 further having executable instructions operable to cause the apparatus to:
collect the information from one or more sensors.
